(19) United States
(12) Patent Application Publication
(10) Pub. No.: US 2008/0046514 A1
(43) Pub. Date: Feb. 21, 2008

(54) SYSTEM AND METHOD FOR ELECTRONICALLY DESIGNATING CO-CHAIRS

(75) Inventors: Chenita D. Daughtry, Roxbury, MA (US); Doris Jones, Somerville, MA (US); Angelo Lynn, Roxbury, MA (US); Ebubechukwu Okafor, Reading, MA (US); Latoya Sankey, Malden, MA (US); Razeyah Stephen, Malboro, MA (US)

Correspondence Address: CANTOR COLBURN LLP - IBM LOTUS, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/465,911

(22) Filed: Aug. 21, 2006

(51) Int. Cl. G06F 15/16; G06F 15/173

(52) U.S. Cl. 709/204; 709/223

(57) ABSTRACT

A system and method that allows electronic collaboration events to be co-chaired, thus eliminating restricted process access or bottlenecks and therefore providing a more efficient electronic collaboration event is provided. The method includes identifying a plurality of peer level chairperson positions for the electronic event and identifying at least one chairperson corresponding to each of the of peer level chairperson positions. The method also includes assigning each of the plurality of peer level chairperson positions make change authority; save change authority; send change authority; and view history authority.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to automated systems for coordinating schedules and activities; and more particularly to electronically designating co-chairs for an on line meeting or event.

2. Description of the Related Art

The rapid growth of networked communications over the last decade, particularly Internet communications, has produced numerous new methods of business communications, e.g. between members of a workgroup. Many activities that were once performed manually can now be automated via computer communications. For example, meeting scheduling typically involves setting up a meeting, identifying the attendees, sending out meeting notices, keeping track of acknowledgements, reserving a conference room, reserving any special facilities (e.g., presentation materials, audio-visual equipment, etc.), sending out reminders, handling schedule and resource conflicts, etc. Until recently, for any given meeting, one or more individuals would typically perform such meeting-related scheduling and coordination manually. This manual scheduling and coordination often requires considerable time and effort. With the advent of widespread computer communications and the widespread availability of e-mail, some software-based systems have been created to facilitate and/or automate much of the drudgery and detail management associated with meeting scheduling.

“Collaboration” software systems such as Lotus Notes produced by IBM Corporation, attempt to coordinate many of the activities between individuals in an organization. Such software typically includes a hierarchical database of contacts and co-workers catalogued by location, project assignments, etc., and a calendar/schedule management facility for scheduling and keeping track of appointments, meetings, activities, deliverables, etc. These systems often include a meeting coordination (sub)system for organizing and scheduling meetings. Such meeting features typically permit a meeting organizer (typically the meeting chairperson or his delegate) to locate and identify attendees based upon their project affiliations, physical location, etc. Once a list of attendees has been identified, the collaboration software typically provides a mechanism whereby all of the various attendees' schedules can be coordinated to identify a time when all attendees will be available.

Attendees with e-mail addresses are notified by the collaboration system via e-mail. Other attendees can be notified by inter-office memorandum, by mail, or by any other suitable mechanism. Collaboration systems often have features that facilitate sending these other forms of meeting notice (e.g., automatic or semiautomatic letter/.memo composition and printing, addressing, envelope printing, etc.).

As used herein, the term “collaboration system” refers to any system for automated coordination and scheduling one or more activities for multiple individuals. Typically, such systems employ client software running on computers assigned to some or all of the individuals, each client having access to a common database. The database can be either centrally located on a main server or distributed across multiple computers.

Although the system described above represents a significant improvement over non-automated methods for organizing meetings, currently with one chair for a meeting/event, the one chair is the only one that can male decisions and see the meeting/event status. In the scenario where we have three, or perhaps more, chairs who share the responsibility for a meeting/event, because you only assign one chair for the meeting/event, the other two chairs would have to depend on the one person to add/remove people to the meeting/event, make updates, etc. This is a bottleneck in cases where people who equally share responsibility can not get in touch with the person or some other circumstance (See FIG. 2). This can be quite time consuming and costly.

### SUMMARY OF THE INVENTION

The shortcomings of the prior art are overcome and additional advantages are provided through the provision of a co-chair capability in an electronic collaboration environment.

In accordance with one embodiment of the present invention a method for initiating a multi chaired event in an electronic collaboration environment is provided. The method includes identifying a plurality of peer level chairperson positions for the electronic event and identifying at least one chairperson corresponding to each of the of peer level chairperson positions. The method further includes at least one chairperson accepting one of the pluralities of chairperson positions.

The invention is also directed towards a method for managing an electronic collaborating event. The method includes designating a plurality of chair positions for the electronic collaborating event and requesting at least one chair person to fulfill at least one of the pluralities of chair positions for the electronic collaborating event. The method also includes assigning at least one chair person at least one permissible chair action.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which allows electronic collaboration events to be co-chaired eliminating restricted process access or bottlenecks; thus, providing a more efficient electronic collaboration event. In accordance with one embodiment of the present invention a program storage device readable by a machine and tangibly embodying a program of instructions executable by the machine to perform a method for initiating a multi chaired event in an electronic collaboration environment is provided. The method includes identifying a plurality of peer level chairperson positions for the electronic event and identifying at least one chairperson corresponding to each of the plurality of peer level chairperson positions. The method further includes at least one chairperson accepting at least one of the plurality of chairperson positions. The method also includes assigning each of the plurality of peer level chairperson positions make change authority; save change authority; send change authority; and view history authority.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a feature of the present invention for electronically designating co-chairs in a meeting coordination system;

FIG. 2 is a block diagram of a multiple chairs according to the prior art;

FIG. 3 is a block diagram of an embodiment of a multiple co-chair capability in an electronic collaboration system in accordance with the present invention shown in FIG. 1;

FIG. 4 illustrates one example of multiple co-chair permission features in a multiple co-chair electronic collaboration system in accordance with the present invention shown in FIG. 3;

FIG. 5 illustrates another example of multiple co-chair permission features in a multiple co-chair electronic collaboration system in accordance with the present invention shown in FIG. 3;

FIG. 6 illustrates another example of multiple co-chair permission features in a multiple co-chair electronic collaboration system in accordance with the present invention shown in FIG. 3; and

FIG. 7 is a flowchart illustrating one method of the present invention shown in FIG. 3.

The detailed description explains the preferred embodiments of the invention, together with advantages and features, by way of example with reference to the drawings.

### DETAILED DESCRIPTION OF THE INVENTION

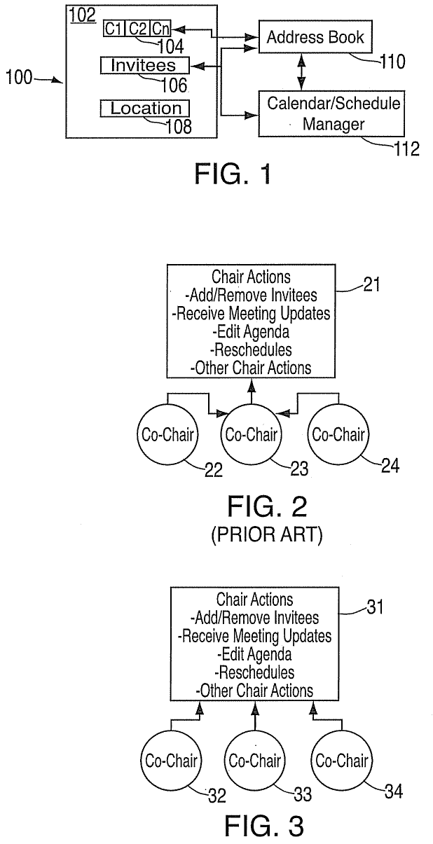

Turning now to the drawings in greater detail, it will be seen that in FIG. 1 there is a block diagram of an of a multiple co-chair capability in an electronic collaboration system in accordance with the present invention.

FIG. 1 is a block diagram of a meeting coordination system 100 of a collaboration system incorporating features of the present invention. A meeting coordination form (or group of forms) is presented to the system user (in this case, a meeting organizer) via a form GUI 102 (Graphical User Interface). Such a GUI 102 typically comprises a graphical or textual form layout, data objects to be represented on the form and form control software for controlling the behavior of the form and display of its associated data objects. In the present context, even a purely text-based command-line interface could be employed.

In the present embodiment, a “chair” data object feature 104 identifies meeting co-chairpersons in accordance with the present invention. An “invitees” data object 106 identifies the list of individuals who will be requested to attend the meeting. A “location” data object 108 identifies the location (meeting place, e.g., conference room) where the meeting will be held. An address book 110, organized as a hierarchical database (HDB), provides a mechanism by which the meeting organizer can quickly locate and identify the invitees to the meeting. The hierarchical organization of the address book allows individuals listed therein to be grouped according to one or more multi-level hierarchical indexing schemes. An example of such a hierarchy would be an organization of individuals by company, division, department, workgroup, job function and project assignment. Another example of a useful multi-level hierarchy would be organization by work location, e.g., company, country, region or city, campus and building. Any single or multi-level indexing scheme can be accommodated in this way.

Each database entry for each individual contains a variety of relevant information such as, location, mailing address, e-mail address, telephone number, link to manager's database entry, link to the individual's calendar/schedule information, etc. A calendar/schedule manager facility 112 provides a mechanism whereby each individual's schedule and appointments are maintained by the collaboration system. By comparing schedules of meeting invitees, the meeting coordination system 100 can identify times when all of the invitees (and the chair) are available. Within the meeting form GUI 102, the meeting organizer can utilize the address book 110 to identify individual meeting invitees and add them to the invitees data object 106. The meeting chair data object 104 is populated in similar fashion. If the meeting organizer is the meeting chairperson, then the user's identity can be used to populate the chair data object 104 automatically by default.

Referring to FIG. 3, there is shown a block diagram of an embodiment of a multiple co-chair capability in an electronic collaboration system in accordance with the present embodiment shown in FIG. 1. Each of the co-chairs 32, 33, 34 are shown on an equal level and each may perform the tasks identified as Chair Actions 31. For example, each co-chair 32, 33, 34 may add or remove invitees, receive meeting updates, edit the agenda, reschedule meetings, and any other suitable chair action.

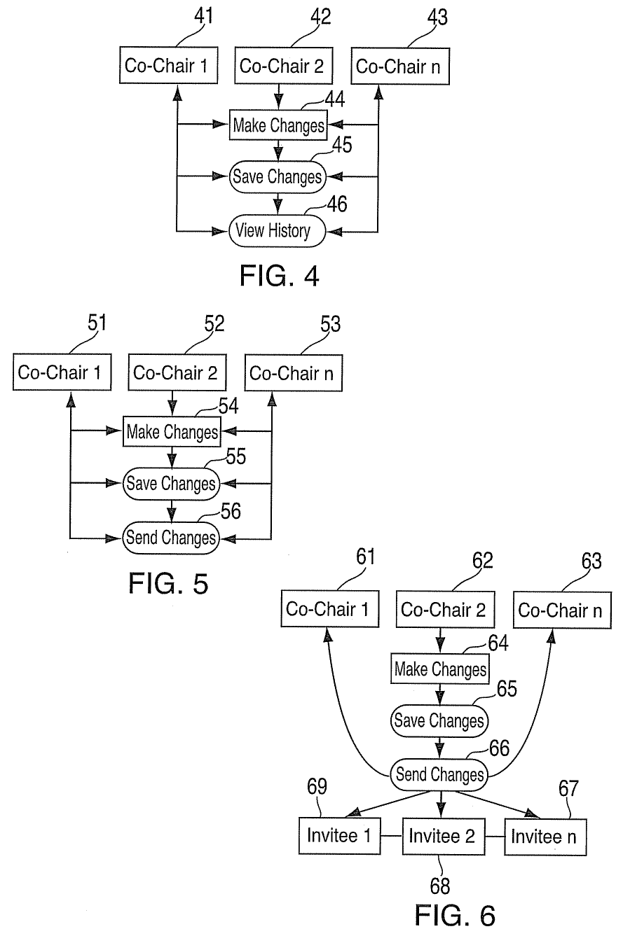

Referring to FIG. 4, there is shown one example of multiple co-chair permission features in a multiple co-chair electronic collaboration system in accordance with the present embodiment shown in FIG. 3. In this embodiment, the co-chairs 41, 42, 43 may make changes 44, save changes, 45, and view change history 46. This list will only be a visible field on the document for individuals with chair privileges and will behave as a deterrent for conflicts. It will be appreciated that any suitable number of co-chairs may be assigned as indicated by Co-Chair n 43. Where n is any suitable integer number.

Referring to FIG. 5, there is shown another example of multiple co-chair permission features in a multiple co-chair electronic collaboration system in accordance with the present embodiment shown in FIG. 3. In this example, the co-chairs 51, 52, 53 can make changes 54, save changes 55, and send changes 56. Again, it will be appreciated that any suitable number of co-chairs may be assigned.

Referring to FIG. 6, there is shown yet another example of multiple co-chair permission features in a multiple co-chair electronic collaboration system in accordance with the present embodiment shown in FIG. 3. In this example, co-chairs 61, 62, 63 may, like the earlier examples, make changes 64, save changes 65, and send changes 66 to each of the other co-chairs. In this example, each of the co-chairs 61, 62, 63 may also send changes to anyone, or all, of the invitees.

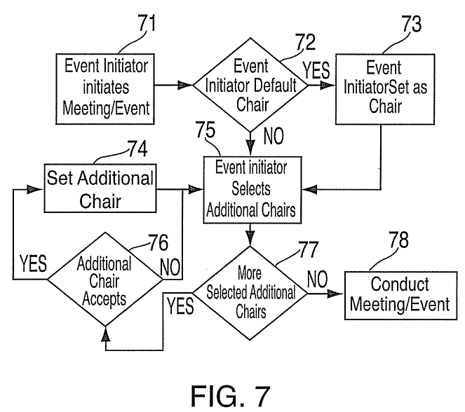

Referring to FIG. 7, there is shown a flowchart illustrating one method of the present embodiment shown in FIG. 3. The event initiator initiates a meeting or event 71 and may be designated as a default co-chair 72, 73. The event initiator then selects additional co-chairs, who must accept the role 76. This process continues 74 until no more additional co chairs are set 77 at which time the meeting or event is conducted 78.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for initiating a multi-chaired event in an electronic collaboration environment, the method comprising:
identifying a plurality of peer level chairperson positions for the electronic event, wherein identifying the plurality of peer level chairperson positions for the electronic event includes identifying at least one chairperson corresponding to each of the plurality of peer level chairperson positions, wherein identifying the at least one chairperson comprises:
the at least one chairperson accepting at least one of the plurality of chairperson positions.

2. The method as in claim 1 wherein identifying the plurality of peer level chairperson positions for the electronic event further comprises assigning each of the plurality of peer level chairperson positions make change authority.

3. The method as in claim 1 wherein identifying the plurality of peer level chairperson positions for the electronic event further comprises assigning each of the plurality of peer level chairperson positions save change authority.

4. The method as in claim 3 wherein assigning each of the plurality of peer level chairperson positions save change authority further comprises assigning each of the plurality of chairperson positions send changes to chairpersons only authority.

5. The method as in claim 3 wherein assigning each of the plurality of peer level chairperson positions send changes authority further comprises assigning each of the plurality of chairperson positions send changes authority to at least one collaboration invitee.

6. The method as in claim 3 wherein assigning each of the plurality of peer level chairperson positions save change authority further comprises assigning each of the plurality of chairperson positions view history authority.

7. The method as in claim 1 wherein the at least one chairperson accepting at least one of the plurality of peer level chairperson positions further comprises the at least one chairperson electronically accepting the at least one of the plurality of peer level chairperson positions.

8. The method as in claim 7 wherein the at least one chairperson electronically accepting the at least one of the plurality of peer level chairperson positions further comprises at least one chairperson assistant electronically accepting the at least one of the plurality of peer level chairperson positions.

9. A method for managing an electronic collaborating event, the method comprising:
designating a plurality of chair positions for the electronic collaborating event;
requesting at least one chair person to fulfill at least one of the plurality of chair positions for the electronic collaborating event;
assigning the at least one chair person at least one permissible chair action.

10. The method as in claim 9 wherein designating the plurality of chair positions for the electronic collaborating event further comprises designating each of the plurality of chair positions for the electronic collaborating event a conflict resolution priority code.

11. The method as in claim 9 further comprising inviting at least one invitee to the electronic collaborating event.

12. The method as in claim 9 wherein requesting the at least one chair person to fulfill at least one of the plurality of chair positions for the electronic collaborating event further comprises electronically receiving an acceptance of the at least one of the plurality of chair positions.

13. The method as in claim 9 wherein assigning the chair person the at least one permissible chair action further comprises associating make changes authority with the at least one chair person.

14. The method as in claim 9 wherein assigning the chair person the at least one permissible chair action further comprises associating send changes authority with the at least one chair person.

15. The method as in claim 9 wherein assigning the chair person the at least one permissible chair action further comprises associating view changes authority with the at least one chair person.

16. The method as in claim 9 wherein assigning the chair person the at least one permissible chair action further comprises associating chair action delegation authority with the at least one chair person.

17. A program storage device readable by a machine, tangibly embodying a program of instructions executable by the machine to perform a method for initiating a multi-chaired event in an electronic collaboration environment, the method comprising:
identifying a plurality of peer level chairperson positions for the electronic event, wherein identifying the plurality of peer level chairperson positions for the electronic event comprises:
identifying at least one chairperson corresponding to each of the plurality of peer level chairperson positions, wherein identifying the at least one chairperson comprises:
the at least one chairperson accepting at least one of the plurality of chairperson positions;
assigning each of the plurality of peer level chairperson positions make change authority;
assigning each of the plurality of peer level chairperson positions save change authority;
assigning each of the plurality of chairperson positions send change authority; and
assigning each of the plurality of chairperson positions view history authority.
